(19) United States
(12) Patent Application Publication
(10) Pub. No.: US 2015/0033939 A1
(43) Pub. Date: Feb. 5, 2015

(54) HYDROSTATIC RADIAL PISTON MACHINE AND PISTON FOR A HYDROSTATIC RADIAL PISTON MACHINE

(71) Applicants: Daniel Svanbäck, Ornskoldsvik (SE); Patrik Isaksson, Mellansel (SE); Andreas Wallgren, Overhornas (SE)

(72) Inventors: Daniel Svanbäck, Ornskoldsvik (SE); Patrik Isaksson, Mellansel (SE); Andreas Wallgren, Overhornas (SE)

(73) Assignee: Robert Bosch GmbH, Stuttgart (DE)

(21) Appl. No.: 14/119,418

(22) PCT Filed: May 18, 2012
(86) PCT No.: PCT/EP2012/002137

§ 371 Date: Feb. 26, 2014

(30) Foreign Application Priority Data
May 23, 2011 (DE) 10 2011 050 576.8

(51) Int. Cl. F04B 1/107; F03C 1/30; F03C 1/22

(52) U.S. Cl. CPC F04B 1/1072; F03C 1/226; F03C 1/0412
USPC 92/13.6

(57) ABSTRACT

A radial piston machine and a piston for a radial piston machine include pistons that are movable in the radial direction and are guided along a lifting surface of a cam ring by a roller. The roller is hydrostatically supported by a pressure groove in a sliding bearing surface of a roller cage. The geometry of the pressure groove is configured such that both the leakage is reduced and the lateral support is improved by enlarging hydrostatic and hydrodynamic surface sections.

The invention relates to a hydrostatic radial piston machine in accordance with the preamble of patent claim 1 and a piston for a radial piston machine of this type.

EP 0 524 437 A1 discloses a radial piston machine, in which a multiplicity of pistons are guided in a cylinder block such that they can be adjusted in the radial direction. Together with a cylinder bore, said pistons delimit a working space, the volume of which changes with the stroke of the pistons. The cylinder is mounted rotatably in a housing, those end sections of the pistons which are remote from the working spaces being supported via rollers on a cam ring. Said cam ring which is connected fixedly to the housing so as to rotate with it has a lifting face which defines the stroke of the pistons during the rotation of the cylinder block. The feed and discharge of pressure medium to and from the respective working spaces is controlled via a valve plate. A hydraulic machine of this type can be operated both as a pump and as a motor.

In the prior art, the individual rollers are mounted hydrostatically on a roller cage which is part of a piston, each roller being engaged around by the roller cage in the radial direction by more than 180° circumferential angle and therefore being secured in the radial direction. The roller cage is configured with a plain bearing face, in which a hydrostatic pressure groove is formed which is in pressure medium connection with the working space, with the result that, apart from throttle and gap effects, a pressure prevails in the pressure groove, which pressure corresponds approximately to that in the working space.

In the radial piston machine according to EP 0 524 437 A1, the rollers are supported hydrostatically in a great angular range. Here, the hydrostatic pressure of course does not act only on the rollers, but rather also on the plain bearing face of the pistons. If the pressure is present over a great angular range, the regions of a piston are bent away somewhat from the roller by the pressure laterally of the roller. In addition, during rolling on the lifting face, the rollers are loaded by a force which is approximately perpendicular on the lifting face and therefore has a component perpendicularly to a plane which is defined by the piston axis and the roller axis, and therefore presses a roller on one side onto a wall of the roller cage. In order to avoid a large gap occurring between a roller and the other wall of a roller cage on account of the mentioned effects, in particular at high pressures, the pistons have been provided with a cutout in the radial piston machine according to EP 0 524 437 A1. This causes the pistons to be weakened centrally and, if the rollers press against the pistons at the lowest points of the roller cage, the regions which are situated laterally of the rollers to be pivoted back to the inside counter to the pressure force which acts on them. The leakage via the gap between the roller and piston is therefore low even when the pressure groove extends over a great angular range.

It is disadvantageous, however, that the pistons are weakened at the bottom of the roller cage and, as a result, the formation of an oil film between the roller and piston is made difficult and is possibly incomplete, in particular in the case of great loads and therefore high pressures.

U.S. Pat. No. 5,979,295 discloses a radial piston machine, in which the roller cage is formed by two cylindrical segment-shaped shell sections which are attached to the piston on both sides.

In contrast, the invention is based on the object of providing a radial piston machine with a satisfactory degree of efficiency and a piston for such a radial piston machine.

This object is achieved with regard to the radial piston machine by the combination of features of patent claim 1 and with regard to the pistons by the features of the further independent patent claim 11.

Advantageous developments of the invention are the subject matter of the subclaims.

According to the invention, the radial piston machine has a cylinder block, in which a multiplicity of pistons are guided radially displaceably, which pistons delimit a working space in each case with a cylinder bore. The pistons are supported on a cam ring in each case via a roller, with the result that they carry out a stroke in the case of a relative movement between the cam ring and the cylinder block. The rollers are received rotatably in a roller cage and are relieved hydrostatically here, a circumferential hydrostatic pressure groove which is preferably connected via a supply duct to the respective working chamber being formed in a plain bearing face.

According to the invention, the pressure groove is positioned in the plain bearing face in such a way that a gap which forms between the outer circumference of the rollers and the plain bearing face does not open or opens only insubstantially toward the pressure groove even in the case of unfavorable operating conditions, with the result that the leaks which were mentioned at the outset can be reduced greatly. A reduction in the angular range, in which the pressure groove lies, also achieves a situation here where the pressure-loaded face on the piston becomes smaller and the lateral regions of the pistons are bent away from the rollers to a lesser extent. A relatively small reduction in the angular range with respect to the known angular range is therefore sufficient for a reduction in the leakage, since the pressure groove not only migrates in the direction of a smaller gap width, but also the gap no longer reaches inward to such an extent.

Satisfactory hydrostatic relief of the rollers and also an improved formation of a hydrodynamic oil film between the roller and the piston are therefore obtained, in particular, in the case of a radial piston machine with solid pistons without an inner recess.

This solution according to the invention deviates from conventional solutions, in which an attempt is always made to ensure the best possible hydrostatic support of the respective roller by way of a hydrostatic pressure groove which extends over as large a circumferential range as possible. It has been shown surprisingly that the degree of efficiency of the radial piston machine, in particular at high pressures, could be improved substantially by the deliberate acceptance of a somewhat reduced active area for the hydrostatic support, as a result of the considerably reduced leakage. This is accompanied by a considerable reduction in the frictional losses in comparison with the conventional solutions, said improvements occurring both in motor operation and in pump operation.

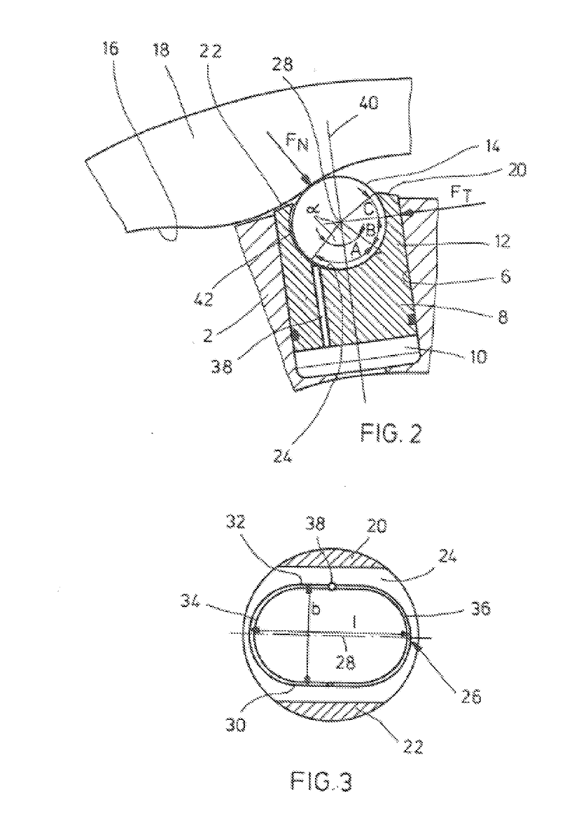

The reduction in the leakage and the improvement of the fluid film formation and the associated reduction in the frictional losses can be improved further if the pressure groove runs within an angular range of ±60° of the plain bearing face in relation to a plane which is defined on the piston axis and the roller axis, that is to say if the pressure groove does not go beyond an angle which is measured from the plane and is smaller than or equal to 60°. Here, the expression “angular range” is understood to mean the angle, as is illustrated in FIG. 2 which will be explained later.

The degree of efficiency of the radial piston machine can be improved further if the pressure groove is formed in an angular range which extends in the circumferential direction of the plain bearing face within ±60° and ±30°, that is to say if the angular range, in which the pressure groove is situated, is not greater than 120° and is not smaller than 60°. Therefore, in the one extreme case, the pressure groove could thus extend on both sides of the plane from 0 to 60° and, in the other extreme case, could extend on both sides of the plane from 0 to 30°. In particular, the angular range should extend at most between ±55° and at least between ±30° in relation to the plane which is defined by a piston axis and a roller axis, that is to say should be at most 110° and at least 60° in magnitude.

The construction of the piston is particularly simple if the roller cage is configured in one piece with a piston skirt.

In one particularly preferred exemplary embodiment of the invention with a further improved hydrostatic support, the extent of the pressure groove in the direction of the roller axis is greater than the extent in the circumferential direction.

In one exemplary embodiment of the invention, the roller cage engages around the respective roller in a positively locking manner, with the result that said roller is received captively.

The hydrostatic pressure groove can be of elongate configuration with two straight groove sections which run approximately parallel to the roller axis and two curved groove sections which connect said straight groove sections.

In a variant of this type, the supply groove can open into the straight groove sections.

The production of deformations and an associated gap formation can be reduced further if the piston is of solid configuration in the part which adjoins the roller cage.

In one preferred exemplary embodiment of the invention, the cylinder block is arranged such that it can be rotated and the cam ring is arranged such that it is fixed to the housing. In a kinematic reversal, however, the cam ring could also be rotated and the cylinder block could be stationary.

The piston according to the invention for a radial piston machine has a roller cage, on which a plain bearing face is formed with a circumferential hydrostatic pressure groove, said pressure groove running in the circumferential direction within an angular range, the maximum width of which is less than or equal to ±60°, is preferably less than or equal to ±55°, but is not less than ±30°.

The pistons are preferably solid without an inner recess.

One preferred exemplary embodiment of the invention will be explained in greater detail in the following text using diagrammatic drawings, in which:

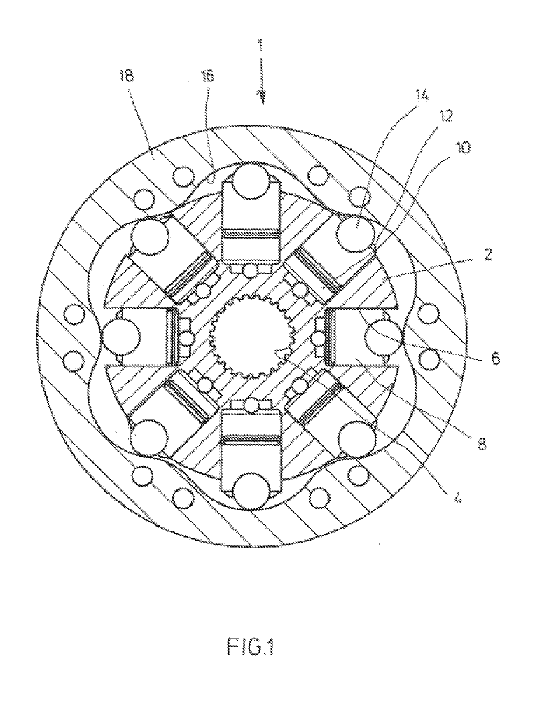

FIG. 1 shows a greatly simplified section through a radial piston machine,

FIG. 2 shows a detailed illustration of the radial piston machine from FIG. 1,

FIG. 3 shows a plan view of a roller cage of the radial piston machine according to FIG. 1, and

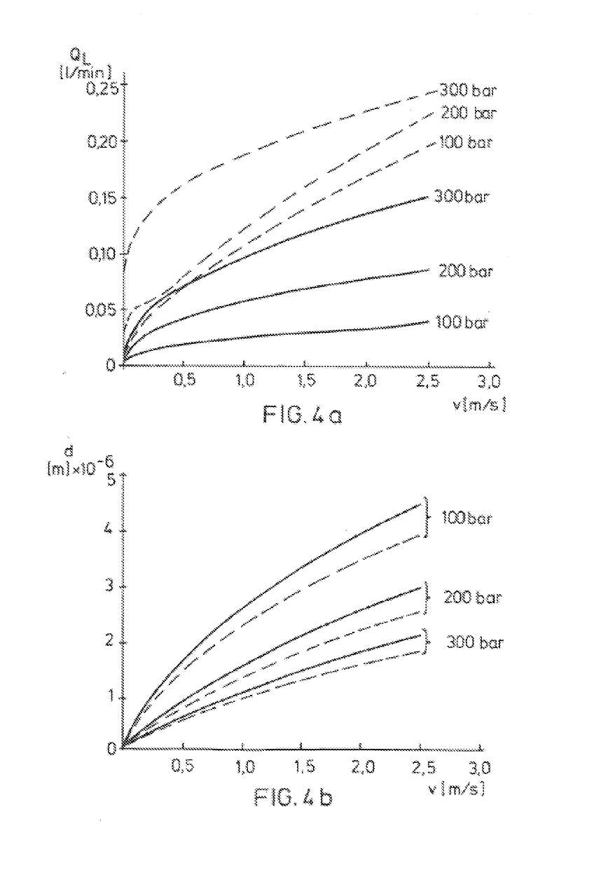

FIG. 4 shows a comparison of the film thickness and the leakage of a radial piston machine according to the invention with a conventional radial piston machine.

FIG. 1 shows a radial section through a radial piston machine 1 according to the invention, in the multiple-piece housing (not shown) of which a cylinder block 2 is mounted rotatably. Said cylinder block 2 has an internal toothing system 4 which is in engagement with a drive or output shaft (depending on the operating mode of the machine). A multiplicity of cylinder bores 6 are formed in the cylinder block 2, in which cylinder bores 6 in each case one solid piston 8 without an inner recess is guided displaceably. Together with the respective cylinder bore 6, said piston 8 delimits a working space 10 which can be connected in an alternating manner to low or high pressure via a valve or control arrangement (not shown). A roller cage 12 is formed on that piston skirt of each piston 8 which is remote from the working space 10, in which roller cage 12 a roller 14 is mounted rotatably which rolls on a lifting face 16 of a cam ring 18 which is arranged such that it is fixed to the housing or forms a part of the housing.

FIG. 2 shows a part region of the radial piston machine 1 with a cylinder bore 6, the piston 8, which can be displaced therein, and the roller 14 which rolls on the lifting face 16 of the cam ring 18. Together with the cylinder bore 6, the piston 8 delimits the working chamber 10 which is connected to high or low pressure depending on the rotary angular position of the cylinder block 2.

According to FIG. 2, the roller cage 12 is configured in one piece with the piston 8 and engages with its side cheeks 20, 22 which can be clearly seen in the plan view according to FIG. 3 around the outer circumference of the roller 14, around a circumferential angle of more than 180°, with the result that said roller is secured in the radial direction. Here, the roller cage 12 forms a circularly cylindrical segment-shaped plain bearing face 24, the diameter of which corresponds to that of the roller 14. For the hydrostatic relief or support of the roller 14, a circumferential hydrostatic pressure groove 26 is formed in the plain bearing face 24, which hydrostatic pressure groove 26, in the exemplary embodiment which is shown, is formed by two straight groove sections 30, 32 which run parallel to the roller axis 28 and two curved groove sections 34, 36 which connect said straight groove sections 30, 32. In the exemplary embodiment which is shown, said curved groove sections 34, 36 are curved in the shape of a circular arc. In the exemplary embodiment which is shown, the ratio of the piston diameter to the roller diameter is approximately from 1.2 to 1.4.

In the view according to FIG. 3, the length l of the pressure groove 26 is considerably greater than its width b. The pressure groove 26 is connected via a supply duct 38 to the working space 10, with the result that approximately the same pressure prevails in the pressure groove 26 as in the working space 10. In the exemplary embodiment which is shown, the supply duct 38 runs parallel to the piston axis 40 (FIG. 2).

In the side view according to FIG. 2, the pressure groove 26 extends in the circumferential direction of the plain bearing face 24 over the region which is labeled by A in FIG. 2 and is considerably narrower than in the conventional solutions. In relation to a plane which runs perpendicularly with respect to the plane of the drawing in FIG. 2 and runs through the piston axis 40 and the longitudinal axis 28 of the roller 14, said region A extends to both sides over an angle a which is 45° in the exemplary embodiment which is shown in FIGS. 2 and 3. In general, the angle a can be at most 60°, preferably at most 55°, and at least 30°. The angle a particularly advantageously lies between 40° and 50°. The width b of the pressure groove is comparatively small in the view according to FIG. 3, which leads to the advantage which will be explained in the following text.

It is assumed for the explanation that the radial piston machine 1 is operated as a motor and a comparatively high pressure prevails in the working space 10. By way of said pressure in the working space 10, the roller 14 is pressed against the lifting face 16, with the result that a force F_{N} acts on the roller 14 on account of the contact of the lifting face 16. In the illustration according to FIG. 2, this force F_{N} presses the roller 14 to the right, with the result that said roller 14 is supported against the transverse force F_{T} of the roller cage 12. On account of an unavoidable deformation of the roller cage 12 and also of the roller 14, an approximately crescent-shaped gap 42 opens in the illustration according to FIG. 2 on the left, which gap 42 leads to a leakage in the prior art which was described at the outset. According to the invention, the angle α and therefore the region A are selected in such a way that the leakage from the pressure groove 26 to the gap 42 is reduced to a minimum. It can be seen in the illustration according to FIG. 2 that the pressure groove 26 still runs just below the gap 42 and therefore substantially no pressure medium connection and therefore a greatly reduced leakage are produced. It is obvious here that the leakage cannot be avoided completely. However, said leakage can be reduced very considerably by way of suitable relative positioning of the pressure groove 26 in relation to the maximum to be expected gap 42 in the case of unfavorable operating conditions.

In the design of the pressure groove 26, moreover, it is to be ensured that the roller 14 is supported hydrostatically in the regions which are labeled by A and by B, and that a hydrodynamic oil film is produced in the region which is labeled by C. In the illustration according to FIG. 2, the regions B and C run outside the region which is engaged around by the pressure groove 26, the active face region B which is enlarged in comparison with the conventional solutions forming a lateral support during starting of the motor. The active face region B which is enlarged in comparison with the conventional solutions acting as a lateral support during starting of the motor. In addition, a large supporting region (B+C) is formed laterally during the rotation, which supporting region makes it possible for a thick hydrodynamic oil film to be formed. Said hydrodynamic oil film effectively separates the lifting roller 14 and the bearing face 64 in the side region of the roller cage 12 both during the working stroke and during the return stroke of the piston 8. In other words, the face regions B and C which are essential for a lateral hydrostatic and hydrodynamic support are increased considerably in comparison with the solutions which were described at the outset by way of the formation of the pressure groove 26 in a comparatively small angular region A (2α), with the result that, with reduced leakage, the friction is reduced considerably both during starting of the motor and during motor operation.

This is clarified using FIG. 4.

FIG. 4a shows a diagram, in which the leakage QL at a piston is contrasted as a function of the sliding speed v in a conventional radial piston machine and a radial piston machine according to the invention, the profiles having been assumed for different pressures (100 bar, 200 bar, 300 bar). The dashed curves show the leakage for a conventional radial piston machine, and the solid lines show the leakage for a radial piston machine according to the invention. It can be seen clearly that the leakage in the case of the radial piston machine according to the invention is considerably lower than in the case of a conventional radial piston machine.

FIG. 4b shows a diagram, in which the minimum film thickness d of the radial piston machine according to the invention and a conventional radial piston machine in the region C is contrasted. In said diagram, the film thicknesses are plotted as a function of the sliding speed v at different pressures (100 bar, 200 bar, 300 bar). The dashed curves show the film thickness for a conventional radial piston machine, and the solid lines show the film thickness for a radial piston machine according to the invention. It can be discerned clearly that the film thickness in the case of the radial piston machine according to the invention is always greater in the comparison pressure range than in the case of a conventional radial piston machine.

Pistons with an angle α of 48° form the basis for the diagrams according to FIGS. 4a and 4b. An angle α of 48° is also a preferred angle.

According to the tests which were carried out by the applicant, a reduction in the leakage in the range from 40% to 75% in comparison with conventional solutions could be achieved by way of the construction according to the invention, the improvement in comparison with the prior art being particularly clear at relatively high pressures. The frictional losses could be reduced, in particular, in the pump mode by from 50% to 75% in comparison with the conventional solutions. However, it is to be noted here that the friction during the starting of the machine can be somewhat greater than in the case of conventional solutions, on account of the reduced supporting face which is determined by the pressure groove 26. According to the invention, this disadvantage is accepted, however, since the abovementioned advantages outweigh it by far.

A radial piston machine and a piston for a radial piston machine are disclosed, in which pistons which can be moved in the radial direction are guided via a roller along a lifting face of a cam ring. The roller is supported hydrostatically via a pressure groove in a plain bearing face of a roller cage. The geometry of the pressure groove is selected in such a way that firstly the leakage is reduced and secondly the lateral support is improved by way of enlarging hydrostatic and hydrodynamic face sections.

### LIST OF DESIGNATIONS

1 Radial piston machine
2 Cylinder block
4 Internal toothing system
6 Cylinder bore
8 Piston
10 Working chamber
12 Roller cage
14 Roller
16 Lifting face
18 Cam ring
20 Side wall
22 Side wall
24 Plain bearing face
26 Pressure groove
28 Axis
30 Straight groove section
32 Straight groove section
34 Curved groove section
36 Curved groove section
38 Supply groove
40 Piston axis
42 Gap

1. A hydrostatic radial piston machine, comprising:
a cylinder block defining a plurality of cylinder bores; and
a plurality of pistons guided radially displaceably in the respective cylinder bores and configured to delimit a working space in each case with the cylinder bore, the pistons being supported on a cam ring in each case via a roller such that they carry out a stroke in the case of a relative movement between the cam ring and the cylinder block,
wherein the roller is mounted hydrostatically such that it is configured to be rotated on a roller cage configured approximately as a cylinder segment, and a hydrostatic pressure groove formed in a plain bearing face, the hydrostatic pressure groove being in pressure medium connection with the respective working space, and
wherein the pressure groove is positioned in such a way that a gap which opens during operation of the radial piston machine between the outer circumference of the roller and the plain bearing face does not pass, or passes only insubstantially, in pressure medium connection with the pressure groove.

2. The hydrostatic radial piston machine as claimed in claim 1, wherein the pressure groove is arranged within an angular range of the plain bearing face which extends at most between ±60° in relation to a plane which is defined by a piston axis and a roller axis.

3. The hydrostatic radial piston machine as claimed in claim 2, wherein the pressure groove runs in the circumferential direction of the plain bearing face within an angular range which extends at most between ±55° and at least between ±30° in relation to the plane which is defined by the piston axis and the roller axis.

4. The hydrostatic radial piston machine as claimed in claim 1, wherein the roller cage is configured in one piece with a piston skirt of the piston.

5. The hydrostatic radial piston machine as claimed in claim 1, wherein the extent of the pressure groove in the direction of the roller axis is greater than the extent in the circumferential direction.

6. The hydrostatic radial piston machine as claimed in claim 1, wherein the roller cage engages around the roller in a positively locking manner.

7. The hydrostatic radial piston machine as claimed in claim 1, wherein the pressure groove is configured with two straight groove sections which run approximately parallel to the roller axis and two curved groove sections which connect said straight groove sections.

8. The hydrostatic radial piston machine as claimed in claim 1, further comprising a supply groove which connects the working space to the pressure groove opening in the region of the straight groove sections.

9. The hydrostatic radial piston machine as claimed in claim 1, wherein the pistons are of solid configuration without a central recess in the part which adjoins the roller cage.

10. The hydrostatic radial piston machine as claimed in claim 1, wherein the cylinder block rotates and the cam ring is fixed to the housing.

11. A piston for a hydrostatic radial piston machine, comprising:
a roller cage on which a plain bearing face is formed with a circumferential pressure groove, the pressure groove running within an angular range which extends at most between ±60° in relation to a plane which is defined by a piston axis and a roller axis.

12. The piston as claimed in claim 11, wherein the piston is of solid configuration without a central recess in the part which adjoins the roller cage.

13. The piston as claimed in claim 11, wherein the pressure groove runs within an angular range which extends at most between ±55° and at least between ±30° in relation to the plane which is defined by the piston axis and the roller axis.
